(19) United States
(12) Patent Application Publication
(10) Pub. No.: US 2015/0046246 A1
(43) Pub. Date: Feb. 12, 2015

(54) Multi-Level Transaction Rebate Computation and Distribution System and Method

(71) Applicants: Li Men, Richmond (CA); Boxu Men, Richmond (CA)

(72) Inventors: Li Men, Richmond (CA); Boxu Men, Richmond (CA)

(21) Appl. No.: 14/303,598

(22) Filed: Jun. 13, 2014

Related U.S. Application Data
(63) Continuation-in-part of application No. 13/737,013, filed on Jan. 9, 2013.

(30) Foreign Application Priority Data
May 13, 2014 (CN) 2014102002660

(51) Int. Cl. G06Q 30/02

(52) U.S. Cl. CPC G06Q 30/0234
USPC 705/14.34

(57) ABSTRACT

The invention provides a system and method to compute and distribute rebates during various business transactions. The system comprises a transaction end, a transaction itemization end, a user end, a data processing end, a coefficient set up end, a rebate division end, a rebate settlement end, and a payout. Rebates can take the form of direct rebate, queued rebate, or reserved rebate. A novel computing method is provided to bring various type or scale of business transactions onto a centralized platform, and redistribute rebates in a timely window.

### CROSS-REFERENCES TO RELATED APPLICATIONS

The present application is a Continuation In Part of application Ser. No. 13/737,013 filed on Jan. 9, 2013, which is hereby incorporated herein by reference in its entirety. The present application also claims priority under the Paris Convention to Chinese application number CN 2014102002660, filed on May 13, 2014, the disclosure of which is herewith incorporated by reference in its entirety.

### TECHNICAL FIELD

The present invention relates to information technology (IT), directed to a system and method to manage rebates incurred during various business transactions. More specifically, the present invention addresses a system and method to compute the accumulation and redistribution of rebates at multiple levels of business transactions. The present invention is applicable to conventional business transactions, as well as to electronic commerce.

### BACKGROUND OF THE INVENTION

Traditional business transactions refer to a direct exchange between currency and goods. In modern era, different types of business transactions evolved into existence, such as Business to Business (B2B), Business to Consumer (B2C), Consumer to Consumer (C2C), Online to Offline (O2O) etc. In the present application, we refer to the term “seller” in its broadest definition, such as a retail business, shopping center, wholesale seller, e-commerce seller or individual seller etc., who provide any product or service. We refer to the term “buyer” also in its broadest definition, such as a business buyer, government buyer, intermediate wholesale buyer, or individual buyer, who receive any product or service. We refer to the term “rebate” as a deduction or discount on a sum of money due in any business transaction. For instance, it can be a cash or credit rebate, points rebate, commission to intermediate buyers or sellers etc.

The very basic function of any type of rebate or discount is to stimulate consumption and to advance a seller's competitive edge among others. It's not difficult to understand that providing rebate will cut into profits received by a seller. One way to offset the profit reduction is to raise the initial price. A product, from being manufactured, packaged, transported, to being sold, typically goes through many intermediate buyers and sellers. To an end consumer, the long chain of intermediate business transactions is virtually opaque. In some sense, the actual cost of a product is invisible, since it has gone through many rounds of price manipulation during such a process. Many large retailers provide rebates or discounts to end consumers. But if the consumer has no sense of the actual cost of a product, rebate or discounts looses its meaning, since the consumer may very well be over paying even after deducting the amount of rebate or discounts received.

Problems also exist in terms of the format of rebates received by a consumer. For example, in the rebate card format, the process begins with rebate queue platform operators printing out rebate cards, which are sold to contracted sellers under certain rates. The sellers will then give out those rebate cards to buyers of their merchandise. After receiving the rebate cards, buyers are still required to log back onto the website platform to type in the numbers and passwords printed on the cards in order for their transactions to officially enter the rebate queue system. This entire procedure is extremely complex, inconvenient, and time-consuming, and does not effectively utilize the straightforwardness, convenience, and efficiency of an e-commerce platform.

In addition to the rebate format mentioned above, a mode of direct rebate exists in current e-commerce application. In this mode, buyers are guided to allied sellers' websites by clicking on the website entrances placed by the rebate platform operators on their website; after completing the purchases, buyers are directed back to the rebate platform website to obtain any rebates. Queue, a mechanism for stimulating consumer demands, is not introduced in this particular mode of rebate; as a result, the amounts of rebates sellers could offer are relatively small and are less attractive to buyers. The fact that buyers are required to enter sellers' shopping platforms only through the rebate website in order to receive purchasing returns works against the common purchasing habits of most buyers. Most buyers tend to search their merchandise of interest directly while shopping online, instead of looking for the website entrances on the rebate platform first. This also causes inconvenience to buyers who are more time-sensitive or have immediate purchasing needs. In addition, poor user experience and transaction security may result from buyers having to frequently jump between the rebate platform and allied sellers' websites during shopping. Furthermore, offline sellers are excluded from this mode of rebate. In sum, several problems still need to be addressed to improve this rebate method.

The present invention intends to address some of the issues illustrated above.

Firstly, the present invention provides a common platform for business transactions from the beginning to the end, including all intermediate levels of buying and selling. Rebates, discounts, or commissions at each level are collectively computed.

Secondly, the present invention improves transparency and profit fairness by moving business transactions such as B2B, B2C, C2C, or O2O, onto a common platform. As a result, an end consumer can share a portion of rebates accrued through various intermediate transactions, which were previously opaque and un-accessible to them.

Thirdly, the present invention provides a mechanism to scientifically control the release of rebate both in value amount and in time, and simultaneously solving the problem of not allotting enough fund for consumers who joint the rebate process in a later time.

Fourthly, the present invention improves the transparency of the rebate system by providing dynamic rebate accumulation, computation, and distribution information, to business owner and consumers alike, in real time.

Fifthly, the present invention ensures consumers to receive rebate in a timely and predictable manner.

Sixthly, the present invention can be implemented online or offline, and can be adapted to fit new and old business models as well as to various consumption habits.

Lastly, the present invention provides a brand new mechanism where consumers can actively earn rebates or discounts by participating in the process, and therefore remain as loyal customers.

### BRIEF SUMMARY OF EMBODIMENTS OF THE INVENTION

The present invention relates to information technology (IT), directed to a system and method to manage rebates incurred during various business transactions. More specifically, the present invention addresses a system and method to compute the accumulation and redistribution of rebates at multiple levels of business transactions. The present invention is applicable to conventional business transactions, as well as to electronic commerce.

In a variant, the transaction rebate computation and distribution system comprising a processor and a computer readable medium having instructions stored thereon, that when executed by the processor cause the processor to generate at least one user end, wherein the user end further comprises at least one cash account or one points account;

at least one transaction end, wherein the transaction end further comprises a transaction settlement unit to complete business transactions by a user, and an identification unit to confirm identities of a user and to retrieve the user's account information;

at least one transaction itemization end, wherein the transaction itemization end further comprises a transaction itemization unit connected to the transaction settlement unit and to the identification unit, to generate a transaction itemization list associated with so identified user;

at least one data processing end, wherein the data processing end further comprises a data extraction unit, connected to the transaction itemization unit, to retrieve data related to business transactions; a rebate calculation unit, connected to the data extraction unit, to calculate percentages of rebate from business transactions, to set aside a percentage of queued rebate and a percentage of reserved rebate; and a communication unit;

at least one coefficient setup end, wherein the coefficient setup end further comprises a rebate time limit unit to setup time period from a begin time and an end time; a numbering unit to arrange time period in a preset order; and a cycling number unit to preset a cycling number used in calculating rebates;

at least one rebate division end, wherein the rebate division end further comprises a rebate division unit to divide a total transaction amount and redistributed the amount into subunits based on decimal numbering system of ten, and a currency conversion unit connected to the rebate division unit and communication unit to convert virtual and actual currencies based on exchange rates;

at least one rebate settlement end, wherein the rebate settlement end further comprises a queuing unit, connected to the rebate division unit, to add new queuing numbers into appropriate queues and to connect them to the transaction itemization list; a queuing rebate unit to determine which queuing number qualifies for rebate and to compute an amount based on the ratio of the queuing number to the cycling number, preset by the cycling number unit; a current cycle rebate unit, connected to the queuing rebate unit, to determine which queuing number did or did not receive any rebate; a reserved rebate unit to distribute reserved rebate to queuing numbers that did not receive rebate from the queuing rebate unit; and a fee calculation unit to compute the currency or points amount;

at least one payout end, comprising a payout unit, connected to the fee calculation unit and to a user's cash and points account, to make deposit accordingly.

In another variant, the transaction rebate computation and distribution system further comprising at least one cloud based main settlement server, connected to the coefficient setup end, the rebate division end, the rebate settlement end, and the payout end.

In yet another variant, the cloud based main settlement server is further connected to the data processing end.

In still another variant, the transaction rebate computation and distribution system further comprises at least one local settlement server connected to the transaction itemization end.

In yet another variant, the local settlement server of claim further comprises a data processing unit.

In a variant, the transaction rebate computation and distribution system, wherein the reserve rebate unit further comprises a rebate identification unit to determine if a queuing number qualifies to receive rebates; a reserve rebate sub unit to retrieve all information related to the queuing number; and a verification unit, connected to the reserve rebate sub unit and to a database to retrieve all information related to the queuing number in every queuing unit; a second fee calculation unit, connected to the verification unit to compute rebate in cash or in points amount; and a second payout unit, connected to the second fee calculation unit and to a user's cash and points account to make deposit accordingly.

In another variant, the transaction rebate computation and distribution system, wherein the main settlement server further comprises a rebate type selection unit, connected to the rebate identification unit, a queuing points unit, and the reserve rebate unit, to determine if a queuing number qualifies for either direct rebate or reserve rebate; a third fee calculation unit, connected to the rebate type selection unit to compute rebate in cash or in points amount; and a third payout unit, connected to the third fee calculation unit and to a user's cash and points account to make deposit accordingly.

In yet another variant, the transaction rebate computation and distribution system further comprises a identity verification unit to securely identify a user via magnetic strip cards, account user ID, account password, or security questions.

In still another variant, the transaction rebate computation and distribution system, wherein the transaction end further comprises a redemption unit, connected to a user's cash or points account, to regulate periodical release of funds or points.

In yet another variant, the transaction rebate computation and distribution system, wherein a rebate percentage is set between 0.1%-99.9%; a cycling number is set to be a natural number equal or larger than 1; a rebate division rate is set between 0.1%-99.9%; a rebate preset ratio is set between 0.1%-99.9%; and a time period is set for every 24 hours.

In a variant, the transaction rebate computation and distribution system, wherein: a rebate percentage is set between 1.0%-10.0%; a rebate preset ratio is set between 30%-70%; and a time period is set for every 1 month.

In another variant, the transaction rebate computation and distribution system, wherein the cycling number can vary depending on various cycles in rebate calculation.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a block diagram of the major components and their interconnections of the multi-level transaction rebate computation and distribution system.

FIG. 2 is a block diagram of an exemplary embodiment 1 of the implementation of the present invention over the network.

FIG. 3 is a block diagram of an exemplary embodiment 3 of the implementation of the present invention over the network.

FIG. 4 is a diagram of an exemplary embodiment 6 of the implementation of the present invention over the network.

FIG. 5 is a block diagram of an exemplary embodiment 2 of the implementation of the present invention.

FIG. 6 is a block diagram of an exemplary embodiment 3 of the implementation of the present invention.

FIG. 7 is a block diagram of an exemplary embodiment 5 of the implementation of the present invention.

FIG. 8 is a block diagram of an exemplary embodiment 6 of the implementation of the present invention.

FIG. 9 is a block diagram of the major components of an exemplary embodiment 2 of the implementation of the present invention.

FIG. 10 is a schematic float chart of a computation method illustrated in an exemplary embodiment 4 of the present application.

FIG. 11 is a diagram of a queuing method illustrated in an exemplary embodiment 1 of the present application.

FIG. 12 is a diagram of yet another queuing method illustrated in an exemplary embodiment 1 of the present application.

FIG. 13 is a diagram of a pre-saved method illustrated in an exemplary embodiment 1 of the present application.

FIG. 14 is a flowchart of a queuing method illustrated in an exemplary embodiment 4 of the present application.

FIG. 15 is a diagram of a queuing method illustrated in an exemplary embodiment 4 of the present application.

FIG. 16 is a flow chart of a rebate distribution itemization list shown to a registered user according to some exemplary embodiment of the present invention.

FIG. 17 is a diagram of the implementation of a cycling number λ in the computation of rebates according to embodiment 5 of the present invention.

The figures are not intended to be exhaustive or to limit the invention to the precise form disclosed. It should be understood that the invention can be practiced with modification and alteration, and that the invention be limited only by the claims and the equivalents thereof

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

### Exemplary Embodiment 1

### Rebate Computation System

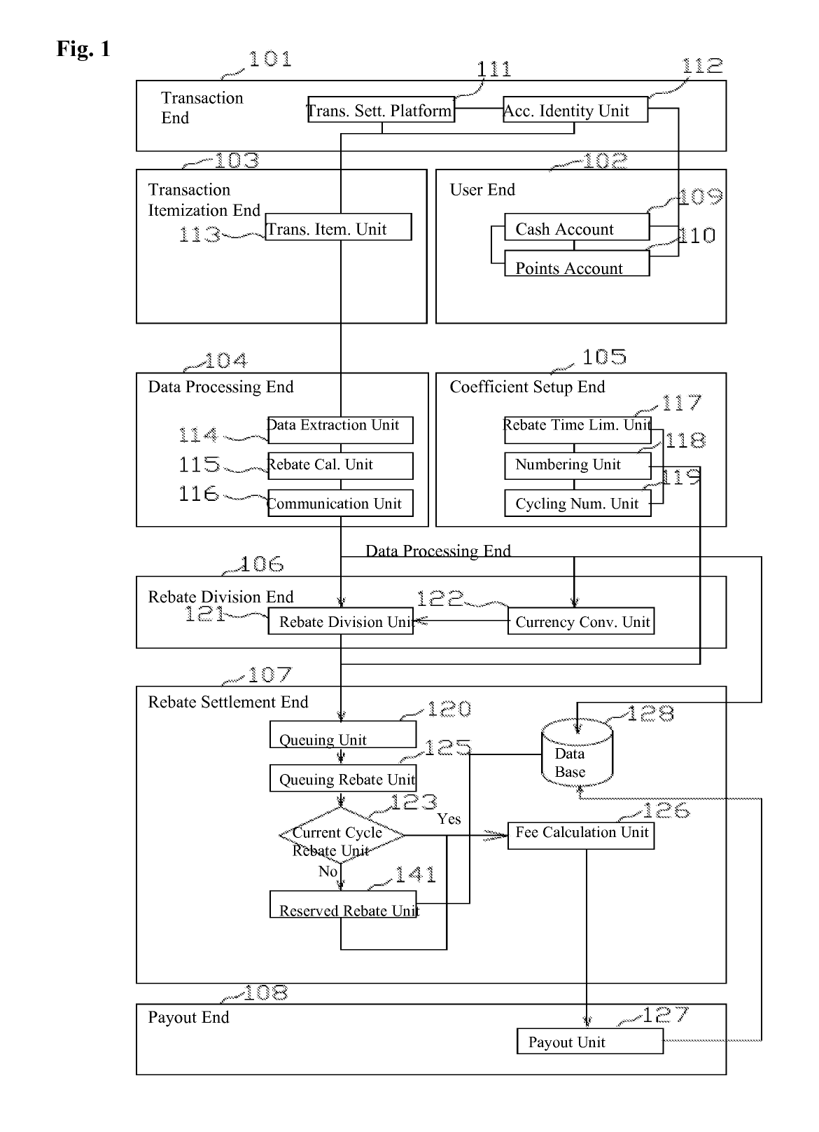

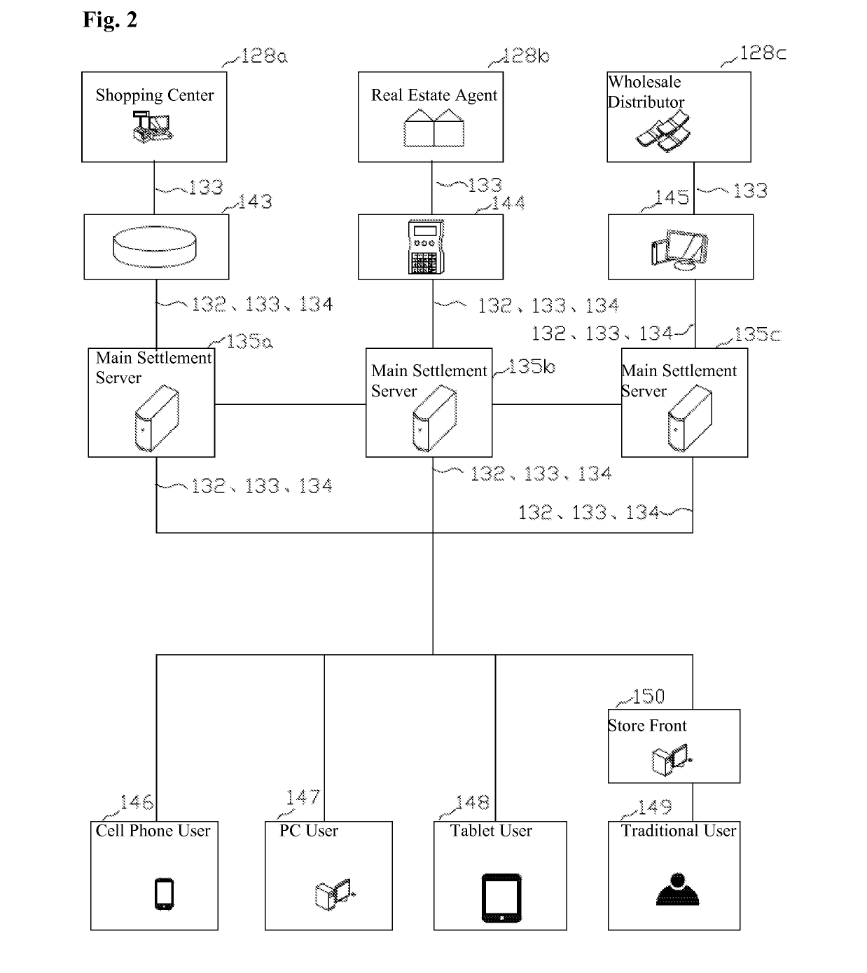

FIG. 1 is a block diagram of the major components and their interconnections of the multi-level transaction rebate calculation and distribution system. The system comprises a Transaction End 101, a User End 102, a Transaction Itemization End 103, Data Processing End 104, Coefficient Setup End 105, Rebate Division End 106, Rebate Settlement End 107, Payout End 108. An example is illustrated in FIG. 2, where a user makes a purchase at a high-end shopping center 128a, or makes a real estate purchase through an agent 128b, or makes a purchase through a traditional wholesale distributor 128c. After any purchase is completed through cash or through bank credit, an Cash Account 109 and a Points Account 110 is opened for the user. Main Settlement Servers 135a, 135b, and 135c, as illustrated in FIG. 2, are connected to Local Processing Units 143, 144, and 145 respectively. Information of various purchases made by the user (128a-c) passed through respective connections 132-4, from Local Processing Units 143-5 to the Main Settlement Servers 135a-c. Cell Phone User 146, PC User 147, Table User 148, and Tradition User 149 all have access to the detailed purchase information. Traditional User 149, who has no direct network connection, will have access to the information through a Store Front 150 set up specifically for that purpose.

User End 102 in FIG. 1 further comprises Cash Account 109 and Points Account 110, where most of the user management takes place. Rebate can be calculated and distributed to either account based on pre-set rules.

Transaction End 101 in FIG. 1 further comprises Transaction Settlement Platform 111 and Account Identity Unit 112. Account Identity Unit 112 is connected to User End 102, in order to confirm user identity and retrieve account information. User identity can be confirmed through magnetic strip cards, smart cards, barcodes, or induction RF cards. Users, via internet, can be identified through user ID, passwords, security questions etc. to ensure security of the accounts. Transaction Settlement Platform 111 can comprise not only those transactions mentioned in FIG. 2 (128a-c), but also large scale retail or wholesale e-commerce, payment management platforms, or even gaming sites.

Transaction Itemization End 103 in FIG. 1 further comprises a Transaction Itemization Unit 113, and is connected to Transaction Settlement Platform 111 and Account Identity Unit 112, for obvious reasons.

Transaction Itemization comprises detailed transaction history, such as dates, time, various locations, amount, points, balances etc. Lists of transactions are generated in chronological order, and are numbered accordingly. For instance, earlier transactions generate lists with an earlier date, and numbered lower in order.

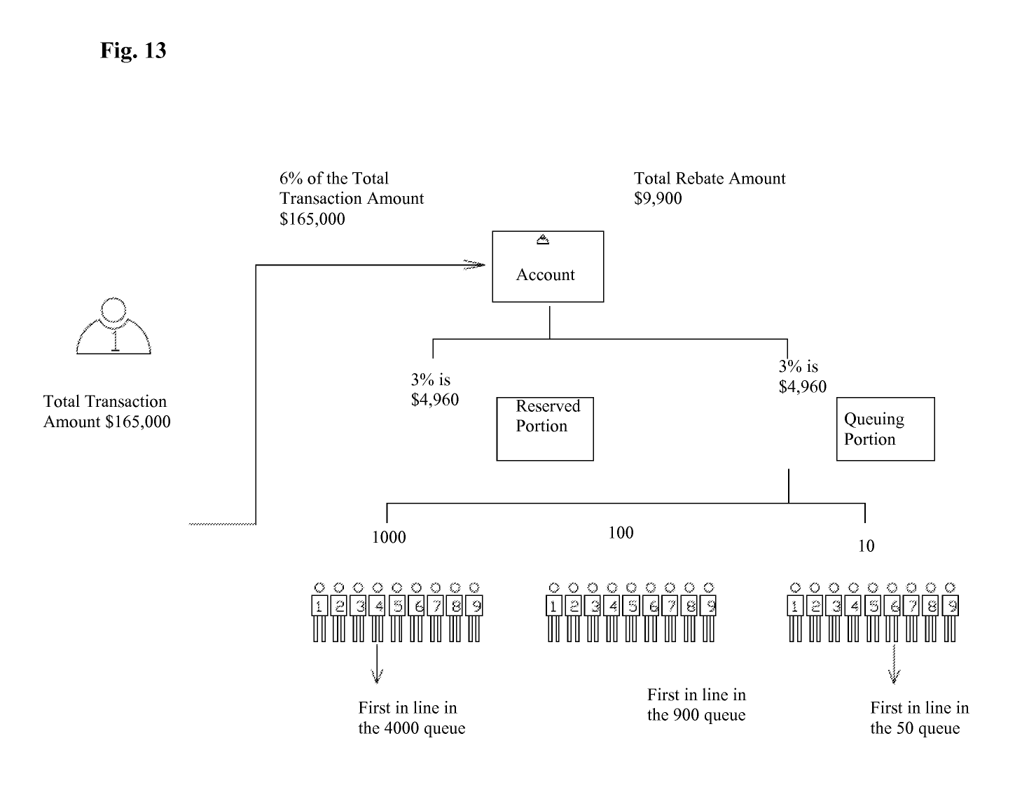

Data Processing End 104 in FIG. 1 comprises Data Extraction Unit 114, Rebate Calculation Unit 115, Communication Unit 116. Data Extraction Unit 114 is connected to Transaction Itemization Unit 113 in order to receive transaction related data, which comprises dates, time, various locations, amount, points, balances etc. Rebate Calculation Unit 115 is connected to Data Extraction Unit 114, in order to calculate rebate amount. Rebates are separated into a reserved portion and a queuing portion. FIG. 13 illustrates a more concrete example, where the particular transaction total amount is $165,000, rebate is preset at 6%, which amounts to $9,900. If the separation percentage is set at 50%, then the reserved portion amounts to $4,960, and the queuing portions amounts also to $4,960.

Communication Unit 116 is connected to Transaction Itemization Unit 113, as well as to the Rebate Division End 106 and Rebate Settlement End 107, via the network (LAN; 133 or WAN; 134). Receipts or transaction confirmations to the user can be used as primers to jump start communications among various units connected through the system according to the present invention.

Coefficient Setup End 105 in FIG. 1 further comprises a Rebate Time Limit Unit 117, a Numbering Unit 118, and a Cycling Number Unit 119.

Time Limit Unit 117 is connected to Queuing Unit 120. For instance rebates can be set to compute every 20 days by the system. Numbering Unit 118 is also connected to Queuing Unit 120, to determine how many time period is within a preset window for rebate computation and assign order accordingly.

Cycling Number Unit 119 is also connected to Queuing Unit 120 to pre-set how many cycle to use for rebate computation.

Rebate Division End 106 in FIG. 1 further comprises a Rebate Division Unit 121 and a Currency Conversion Unit 122.

Rebate Division Unit 121 redistribute amounts based on units by decimals of 10. For instance, the total amount is $777, and is distributed into units of 700, 70, and 7; By the same token, $4,040 is distributed into units of $4,000 and $40.

Currency Conversion Unit 122 is connected to Rebate Division Unit 121 and Communication Unit 116, in order to determine the exchange rate between virtual and actual currencies.

Rebate Settlement End 107 in FIG. 1 further comprises Queuing Unit 120, Current Cycle Rebate Unit 123, Reserved Rebate Unit 141, Queuing Rebate Unit 125, and Fee Calculation Unit 126.

Queuing Unit 120 is connected to Rebate Division Unit 121 to determined the order of queuing, and connect them based on information extracted from the transaction itemization list. For instance, numbering at the 100 decimals are 100, 200, 300, 400, 500, 600, 700, 800, and 900. In a unit of 700 as in the previous example, a new queuing number is added. By the same token, a new queuing number is added the units 70 and 7. If the unit number is 0, it will be discounted. In addition, if a unit already comprises n numbering, the new queuing number will be n+1. The order within a queue is determined by the numbering order from the transaction list. Earlier dates of transaction translated to smaller transaction number, which corresponds to earlier dates to receive rebates.

Queuing Rebate Unit 125 is connected to Queuing Unit 120. Within a pre-set time period, when the numbers within a queue reaches n×Cycling Number, the first n-th number in the queue will qualify for rebate. N is a natural number.

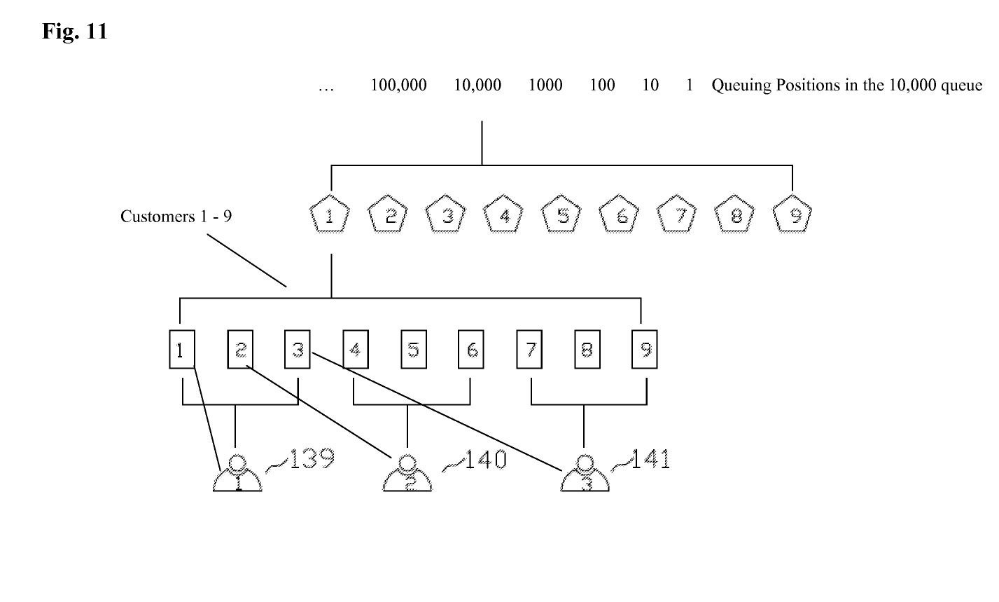

FIG. 11 illustrates the above rule in a more concrete example: Queuing units are set at: single digit, 10, 100, 1000, 10,000, 100,000, and above. Each unit has 9 queuing position. For instance, within the 10,000 unit, they are 10,000, 20,000, 30,000, 40,000, 50,000, 60,000, 70,000, 80,000, and 90,000. A large shopping center set its rebate cycle as 1 month, and there are 9 customers in the queue. If the cycling number is set at 3, customer 1 (139) will receive rebates calculated based on values accumulated from customer 1, 2 and 3. Customer 2 (140), will receive rebates calculated based on values accumulated from customer 4, 5, and 6. Customer 3 (141), will receive rebates calculated based on values accumulated from customer 7, 8, and 9.

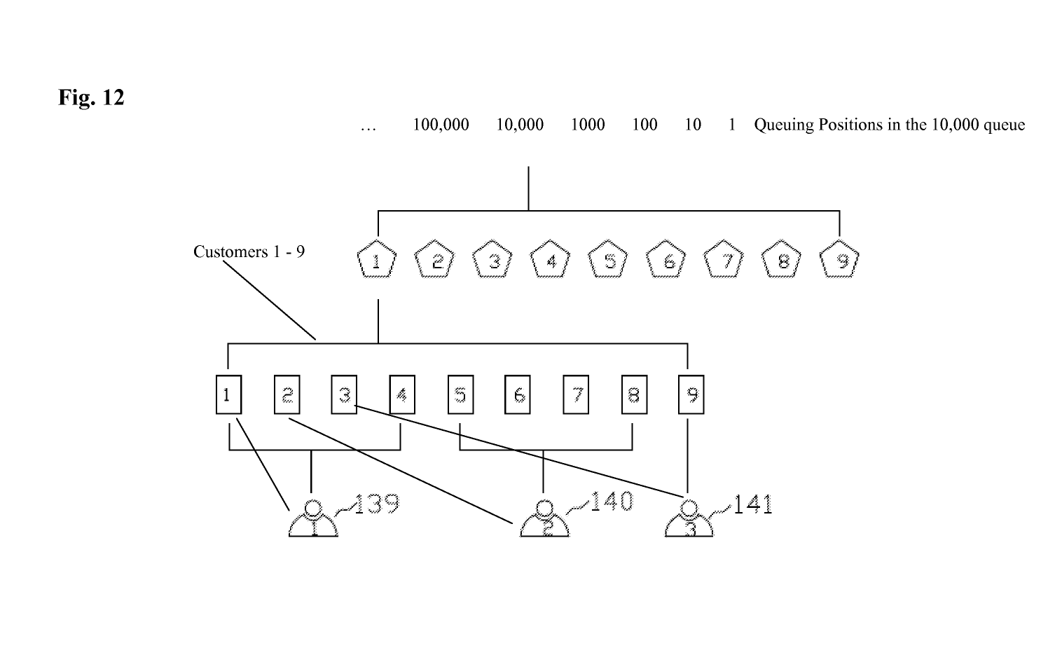

FIG. 12 illustrate the above example, but with the cycling number set at 4. Customer 1 (139), in this scenario, will receive rebates calculated based on values accumulated from customer 1, 2, 3, and 4. Customer 2 (140), in this scenario, will receive rebates calculated based on values accumulated from customer 5, 6, 7, and 8. Customer 3 (141), in this scenario, will receive rebates calculated based on values accumulated from customer 9 only. In both above examples, illustrated in FIG. 11 and FIG. 12. Customers 4-9 does not qualify for rebates from accumulated values from all 9 customers. They, however, will share the reserved portion of the rebates calculated from the Reserved Rebate Unit 141.

In addition, one or a series of special numbers can be pre-set in the Queuing Rebate Unit 125. For instance, queuing number that matches the special number, can be moved forward to enjoy similar rebates calculated for customer 139, 140, and 141. They will be remove from the queue afterwards, so that they do not qualify for rebates calculated from the Reserved Rebated Unit.

Database 128 is connected to Data Processing End 104, Reserved Rebate Unit 141, Payout Unit 127. Database contains information of the transaction, queuing, rebate calculation, payout etc for the entire system.

Current Cycle Rebate Unit 123, Queuing Rebate Unit 125, and Reserved Rebate Unit 141 are connected, to determine which transaction has been included in the rebate calculation. Transactions included in the rebate calculation will be funneled to Fee Calculation Unit 126. Transactions not included will be directed to the Reserved Rebate Unit 141.

Reserved Rebate Unit 141 is used to distribute rebates for left over queuing numbers from the Queuing Rebate Unit 125.

Fee Calculation Unit 126 calculates the actual rebate amount in currency or in points.

Payout End 108 in FIG. 1 comprises Payout Unit 127, connected to Fee Calculation Unit 126, Cash Account 109 and a Points Account 110. Funds in currency are added to the Cash Account 109. Points are added to the Points Account 110.

### Exemplary Embodiment 2

### Rebate Computation System (Queued Rebate, Reserved Rebate, and Direct Rebate)

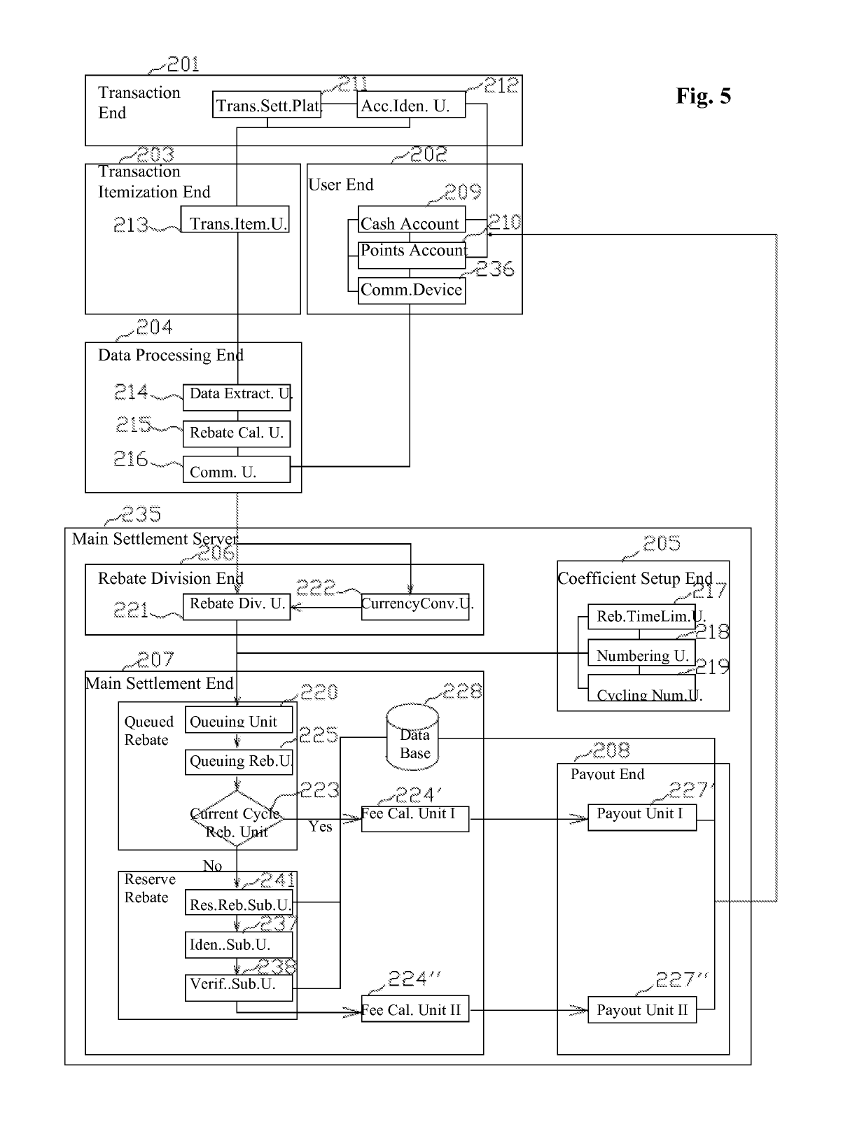

FIG. 5 is a block diagram of an exemplary embodiment 2 of the implementation of the present invention. Coefficient Setup End 205, Rebate Division End 206, Rebate Settlement End 207, Payout End 208 are connected to a Main Settlement Server 235.

Fee Calculation Unit I 224′ and Payout Unit I 227′ are connected to a Current Cycle Rebate Unit 223. Rebates in cash or points are calculated based on queuing order that qualifies for rebates in a pre-set period, similar to examples illustrated in FIG. 11 and FIG. 12.

Fee Calculation Unit I 224′ and Payout Unit I 227′ are also connected to Cash Account 209 and Points Account 210 in a User End 202. Rebates calculated from the Fee Calculation Unit I 22 will be deposited in user's accounts accordingly.

Reserve Rebates comprises a Reserve Rebate Sub-Unit 241, Reserve Rebate Identification Sub-Unit 237, and a Verification Sub-Unit 238.

Reserve Rebate Sub-Unit 241 and Reserve Rebate Identification Sub-Unit 237 are connected to the Current Cycle Rebate Unit 223, so as to retrieve data regarding the total amount of reserved portion of the rebate and any related information for a pre-set period.

Reserve Rebate Identification Sub-Unit 237 determines the eligibility of rebate based on information retrieved from Current Cycle Rebate Unit 223. For instance, customer A within the Xth period was queued into a 700 unit, but did not qualify to receive accumulated rebate, and his or her number will be entered into the Reserve Rebate Sub-Unit 241, and move on from there.

In an example illustrated previously, customer A within Xth period can be queued in the 700, 70, or 7 units at the same time, based on the value of the purchase and the rules set in the present invention. If at the end of that period, the number queued in the 7 unit qualifies for accumulated rebate, but not the number queued in the 70 and 700 units. Then the system can re-enter the number queued in the 70 and 700 units to the next period, instead of funneling them to the reserve rebate pool.

Verification Sub-Unit 238 is connected to the Reserve Rebate Sub-Unit 241 and Database 228 in order to verify relevant information. Whether a customer qualifies for accumulated rebate or reserve rebate, such as illustrated in the previous example in the 700 unit, will be determined here, and move on to the next step accordingly.

Fee Calculation Unit II 224″ is connected to the Verification Sub-Unit 238, to calculate cash or points amount from the reserved rebate pool.

Payout Unit II 227″ and Fee Calculation Unit II 224″ are also connected to Cash Account 209 and Points Account 210 in a User End 202. Rebates calculated from the Fee Calculation Unit I 22 will be deposited in user's accounts accordingly.

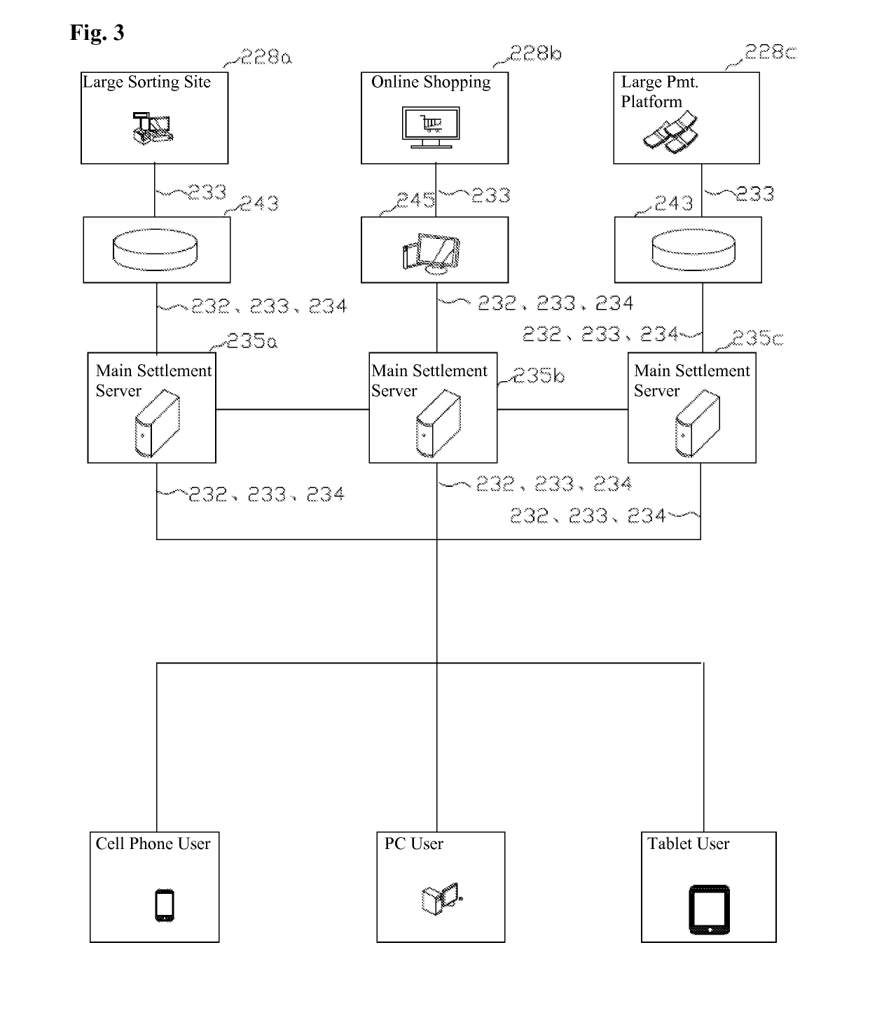

FIG. 3 is a block diagram of an exemplary embodiment 3 of the implementation of the present invention over the network. Main Settlement Server 235a, 235b, and 235c can be connected to multiple businesses 228a, 228b, and 228c, from all over the world. Different business transactions can be centralized into the same platform. Rebates can be calculated simultaneously, and thus greatly shortened the cycles for a customer to receive rebates, whether in cash or in points. In an ideal scenario, a customer can be eligible to receive rebates on a rate of every other day, which greatly increases the incentive for him or her to participated in the process. In particular, a customer can expect rebates on a regular basis, so long as the business transactions are tabulated in the platform set up by the present invention. A customer does not need to track each and every rebate from different businesses at all.

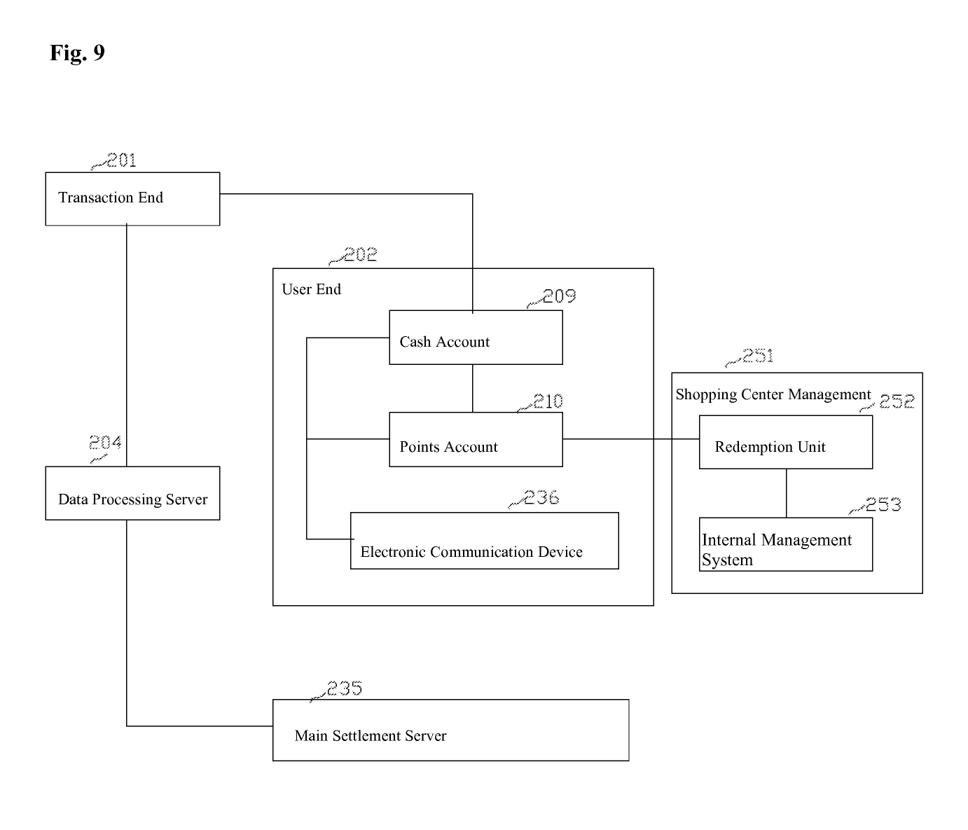

FIG. 9 is a block diagram of the major components of an exemplary embodiment 2 of the implementation of the present invention. In this particular example, the present invention is implemented in a large shopping center. For instance, a Shopping Center Management End 251 comprises a Redemption Unit 252 and Internal Management System 253. The Redemption Unit 252 is connected to the User End 202 and Points Account 210, via the Network 232 (LAN; 233) or (WAN; 234) to the Main Settlement Server 235, and its Payout Units 2271 and 22711. Points instead of cash are deposited to a user's account accordingly

### Exemplary Embodiment 3

### Rebate Calculation System (Queued Rebate, Reserved Rebate, and Direct Rebate)

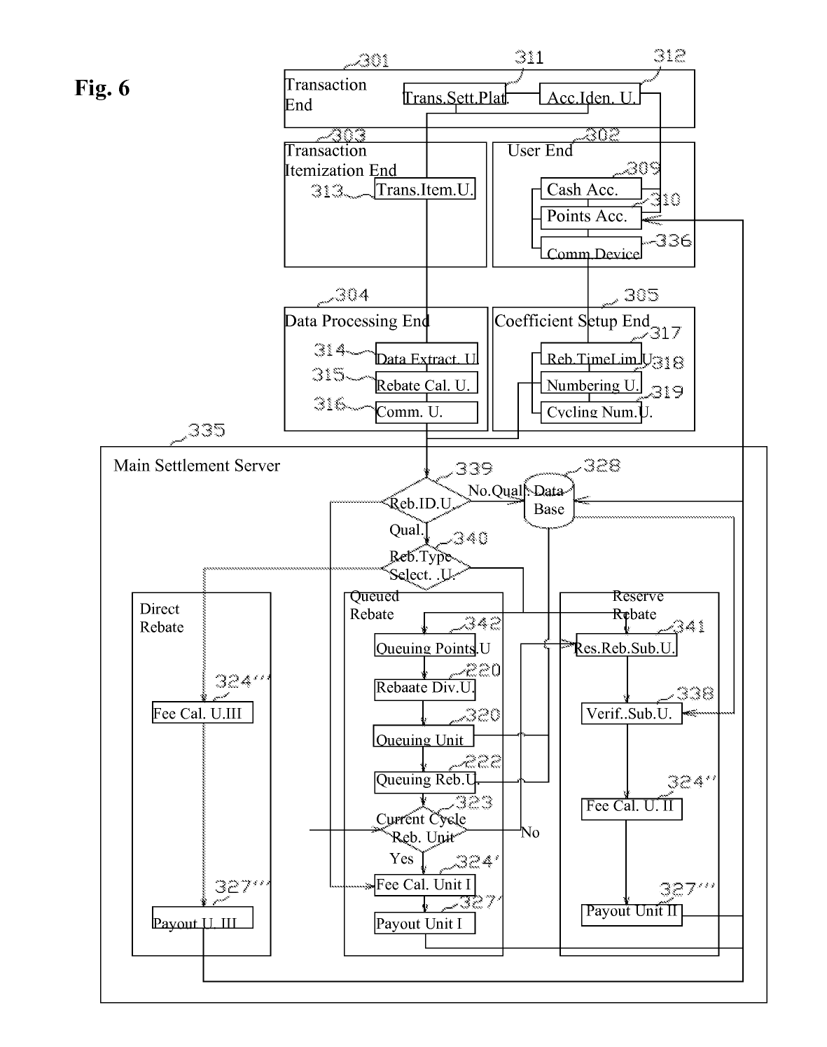

FIG. 6 is a block diagram of an exemplary embodiment 3 of the implementation of the present invention. A Main Settlement Server 335 also comprises a Rebate Type Selection Unit 340, a Rebate Identification Unit 339, Queuing Points Unit 342, and connected to Reserve Rebate Sub Unit 341. Rebate type comprises Queued Rebate, Reserved Rebate, and Direct Rebate.

Fee Calculation Unit III 324111 is connected to the Rebate Type Selection Unit 340 to determine which rebate type to use.

Payout Unit III is connected to the Fee Calculation Unit III 324111 and a Points Account 310, so as to deposit points into a user's account after the rebated amount is determined.

Rebate Identification Unit 339 is connected to a Data Processing End 339. Data can also be stored in a Database 328.

### Exemplary Embodiment 4

### Queued Rebate

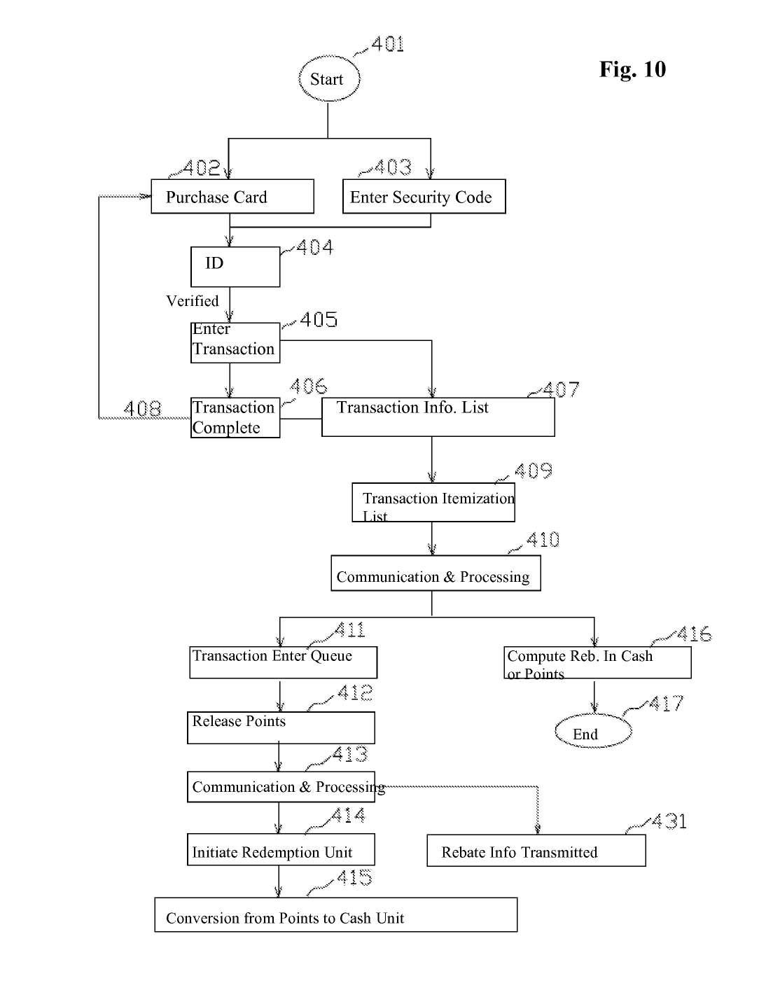

FIGS. 10, 14 and 15 illustrate the overall concept of the present invention in an exemplary embodiment. FIG. 10 is a schematic float chart of a calculation method for Queued Rebate, as illustrated in an exemplary embodiment 4 of the present application. For example, the process starts at 401, where a transaction is taking place, when a user use his or her Purchase Card 402 and Code 403 to purchase an item. After the card swipe, the user is Identified 404 and Approved 405, and the transaction is Completed 406. For online users, this process starts with account set up and login, whether though PC, Cell phone, or Tablet, assuming the businesses providing the merchandize or service subscribe to the rebated system from the present invention.

A Transaction Information List 407 comprising user ID, Account Number, Shopping Center Code, Product Code, Date, Time, Points Account Balance etc. is generated. If a user initiated a brand new account, related information will cycle through the pathway illustrated via 408. In general, as soon as each transaction completes, a Transaction Itemization List 409 is generated.

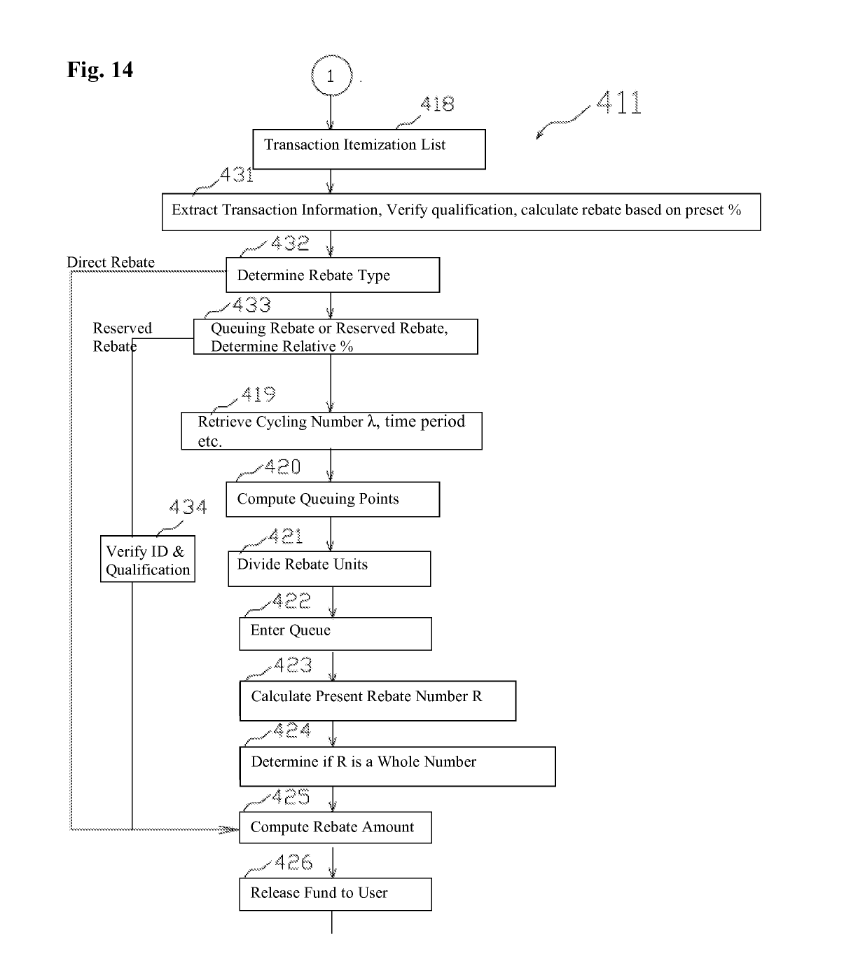

After a Transaction Itemization List 409 is generated, it is transmitted to a Main Processing Unit 410, via the network. The Transaction in turn enters the queue for rebate at 411, and information related to queuing is also transmitted to the user 416 via emails or text messages etc. Details of the queuing 411 will be expanded in FIG. 14.

FIG. 14 is a flowchart of a detailed queuing process 411 illustrated in an exemplary embodiment 4 of the present application. The input of the queuing process 411 is a Transaction Itemization List 418, where detailed information is extracted at 431. The transaction is then determined at a process 432 to enter Direct Rebate or Queued Rebate. If a Direct Rebate pathway is selected, the relevant information is directed to 425 where the final rebate is calculated. If a Queued Rebate pathway is selected, the relevant information is further separated into a queued accumulated rebate and a reserved rebate pathway at 433. A Cycling Number (λ), start and end time period etc is set up at 419. In an example illustrated at 427, the total transaction amount is $7,700, with a 10% rebate, which amounts to $770.

Rebate Division Unit 421 redistribute amounts based on units by decimals of 10. For instance, the total amount is $777, and is distributed into units of 700, 70, and 7; By the same token, $4,040 is distributed into units of $4,000 and $40.

Queuing Unit 422 is connected to Rebate Division Unit 421 to determined the order of queuing, and connect them based on information extracted from the transaction itemization list. For instance, numbering at the 100 decimals are 100, 200, 300, 400, 500, 600, 700, 800, and 900. Numbering at the 10 decimals are 10, 20, 30, 40, 50, 60, 70, 80, and 90. In an expanded view in 428, the rebate amount of $777 is queued in units of 700, 70, and 7. If the unit number is 0, it will be discounted. If in a unit 700 as in the previous example, n entries already exist, then the new entry will take the number of n+1 in the queue. By the same token, a new queuing number is added the unit 70 as m+1 and p+1 in unit 7. Queue numbers (n+1), (m+1), and (p+1) are all connected to the same exemplary transaction #1234567. Among the three queuing numbers, the smaller the number, the earlier the position in the queue, which corresponds to an earlier probable date for receiving rebates.

Whenever a new queue number is entered into a queuing order, the following calculation takes place at step 423, based on equation (3), to calculated the Present Rebate Number R:

R=Lq÷λ (3)

R represents the Present Rebate Number, Lq represents the newly entered Queuing Number, and λ represents the Cycling Number;

If R is a whole number, the system is prompted to accept the corresponding transaction number as qualifying candidate to enter and to receive rebate. Conversely, if R is not a whole number, the system is prompted to keep the transaction number in the queue longer, and no rebates will be calculated until more entries enter into the same queue.

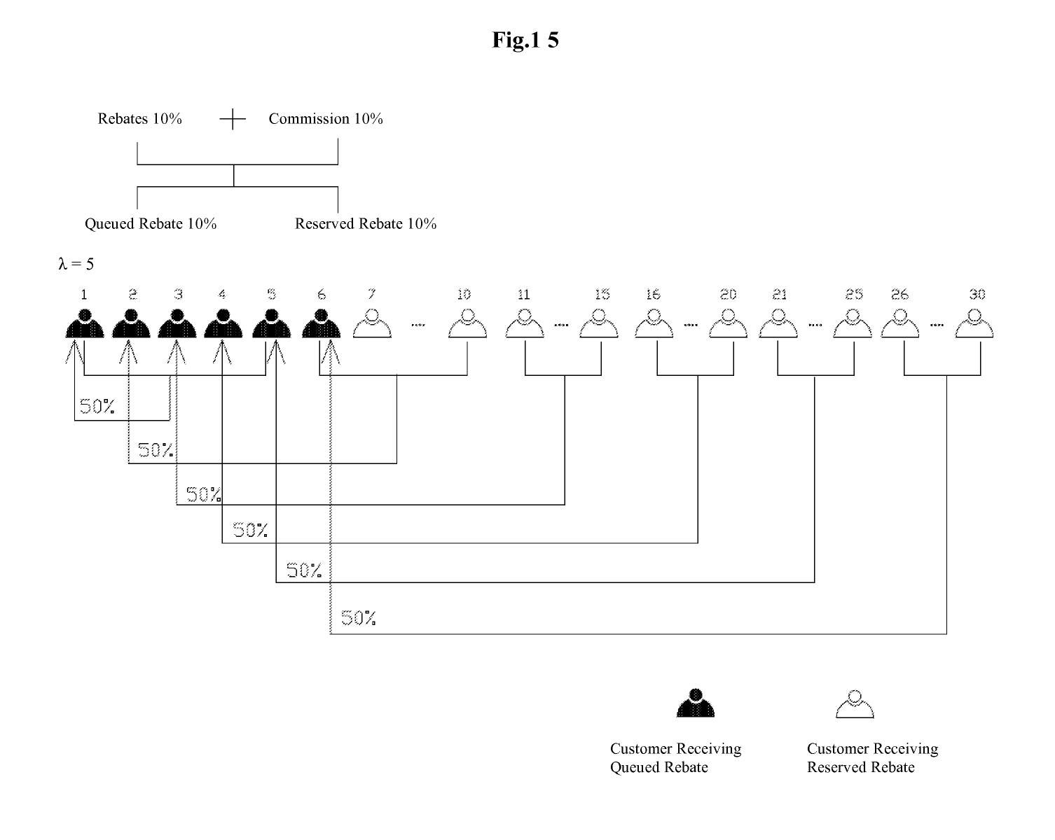

FIG. 15 is a diagram of a concrete example of the queuing method illustrated previously. A Cycling Number λ in Queue X is set at 5. In a given period, there are 30 entries in sequential queuing order. When the 5^{th} entry enters the queue, based on R=Lq÷λ=5±5=1, which means customer associated with queuing position 1 qualifies to receive rebates. By the same token, when the 30^{th} entry enters the queue, based on R=Lq÷λ=30±5=6, which means customer associated with queuing position 6 qualifies to receive rebates. Assuming 10% of Rebates and 10% Commission are the total amount allotted for all customers to receive as rebates, 10% will be allotted to Queued Rebates, and 10% will be allotted to the Reserve Rebates. At the end of the period, customers associated with queuing order 1-6 will receive 50% of the Queued Rebates, and customers associated with queuing order 7-30 will receive 10% of the Reserved Rebates.

In addition, one or a series of special numbers can be pre-set by the system. For instance, queuing number that matches the special number, can be moved forward to enjoy similar rebates calculated for Queued Rebates. They will be remove from the queue afterwards, so that they do not qualify for rebates calculated from the Reserved Rebated Unit.

If the above example corresponds to the rebates calculated for the Unit 700, the queuing number associated with transaction #1234567 is n+1. For the same transaction number, the customer also enjoys rebates calculated from unit 70 and unit 7, with corresponding queuing numbers m+1 and p+1.

The above example demonstrates one of the goals of the present invention, which is to use rebates as incentive for customers to participate in consumption. Depending on the volume of transactions, the present invention greatly improves the frequency of rebates received by customers. Various control mechanisms, such as adjusting the size of the queue, cycling numbers, time periods etc., allows fine tuning of the system. Businesses that participate in the platform provided by the present invention can in turn benefit from it both in terms of the volume of transactions, as well as from the management aspects of the business.

In FIG. 10, after the rebates are calculated at 412, it will be released to customer accounts 413. One possibility is to allow businesses themselves to control (414) the release of funds or points to customer by setting time periods, such as every 30 days or month. Another possibility is to set the release time automatically (415), and as soon as the rebate period ends, funds or points are directly released to the accounts, and allowing users to utilized the rebate for future purchase.

Finally, a Notification Unit 431 sends out notices to users, informing them of information such as the balance, expiration dates, options of redemption, or even options to enter lottery etc.

### Exemplary Embodiment 5

### Large Scale E-Commerce

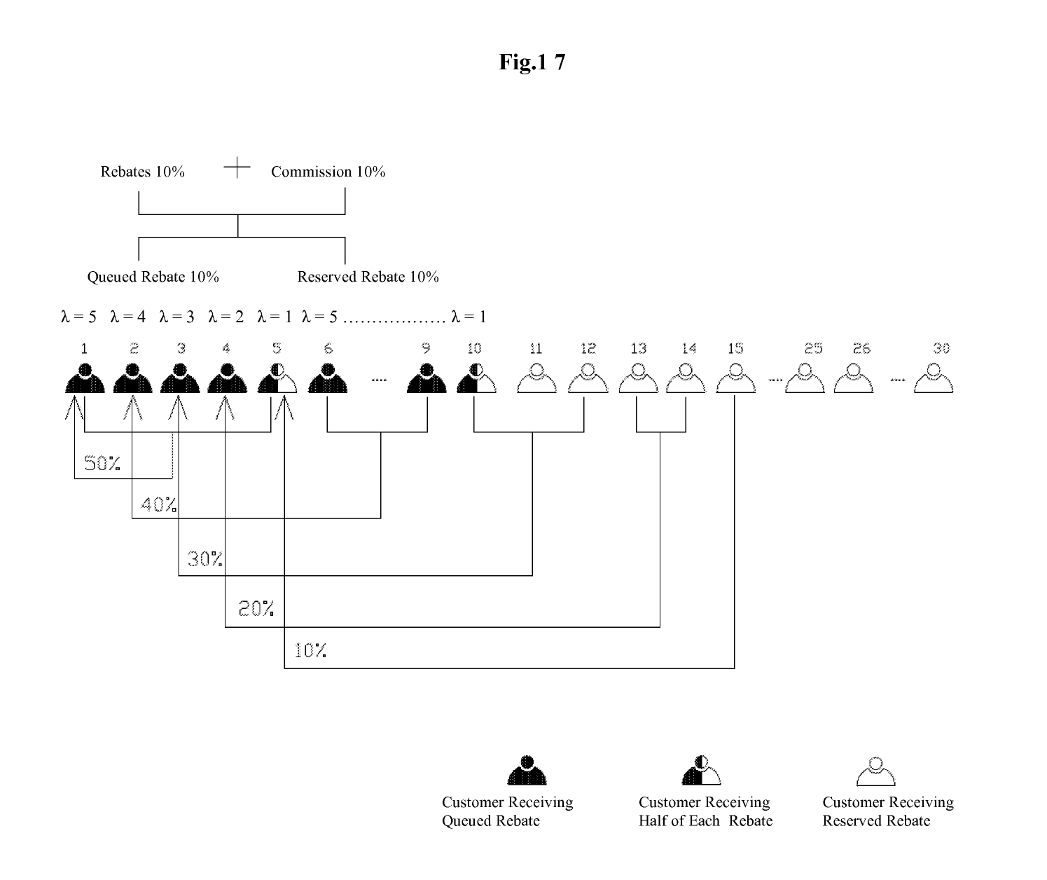

FIG. 17 is a diagram of the implementation of a cycling number λ in the calculation of rebates according to some embodiment of the present invention. Assuming 10% of Rebates and 10% Commission are the total amount allotted by Business X for all customers to receive as rebates, and 10% will be allotted to Queued Rebates, and 10% will be allotted to the Reserve Rebates. At the end of one period, there are 30 numbers in the queue, 5 Cycling Number λ were pre-set in this example. They are λ=5, λ=4, λ=3, λ=2, and λ=1. The numbering in any queue is ordered from small to large. After cycling through all the cycling number, customers at queue number 1 and 6 receives 50% of the rebate, customers at queue number 2 and 7 receives 40% of the rebate, customers at queue number 3 and 8 receives 30% of the rebate, customers at queue number 4 and 9 receives 20% of the rebate, and customers at queue number 5 and 10 receives 10% of the rebate. In order to compensate customers at queue number 5 and 10, they will receive a 10% from the Reserved Rebate pool. In this scenario, 10 customers can receive rebates higher at 50%, 40%, 30%, 20%, and 20%. The remaining customers with larger queuing number will share the funds from the Reserved Rebate pool.

The platform set up by the present invention can accommodate customers with different levels of consumptions in terms of $ amount. The platform can also accommodate businesses setting their own rebate % at different instances.

### Exemplary Embodiment 6

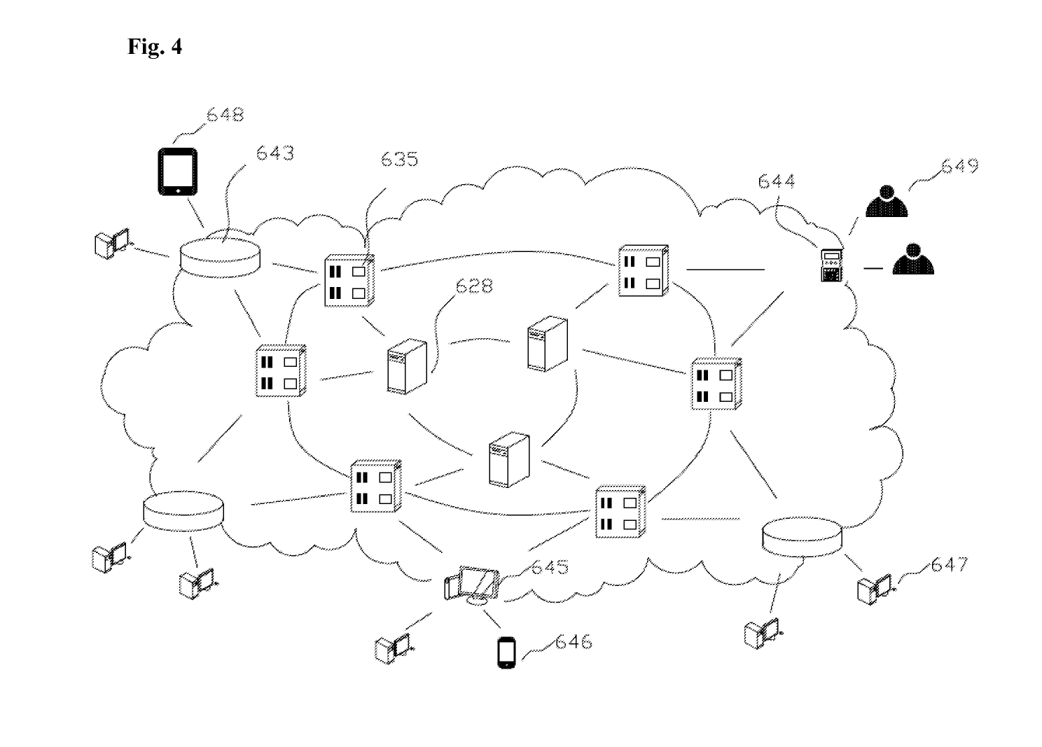

FIG. 4 is a block diagram of an exemplary embodiment 6 of the implementation of the present invention over the network. The present invention can be set up as a cloud based platform to accommodate both on the network and off the network business transactions. Cell Phone Users 646, PC Users 647, and Tablet Users 648 can be connected via Large Scale Data Processing Unit 643 or Small Scale Data Processing Unit 645 to the Main Settlement Servers 635. Traditional Users 649 can also participate via connections between Local Settlement Servers 644, Transitional Data Exchange Units 628, and the Main Settlement Servers 635. The implementation of the present invention practically allows users and businesses around the world to participate on the same platform. The volume of transactions taking place will greatly stimulate the rate of rebate a user can receive, and thus improve user incentive to participate.

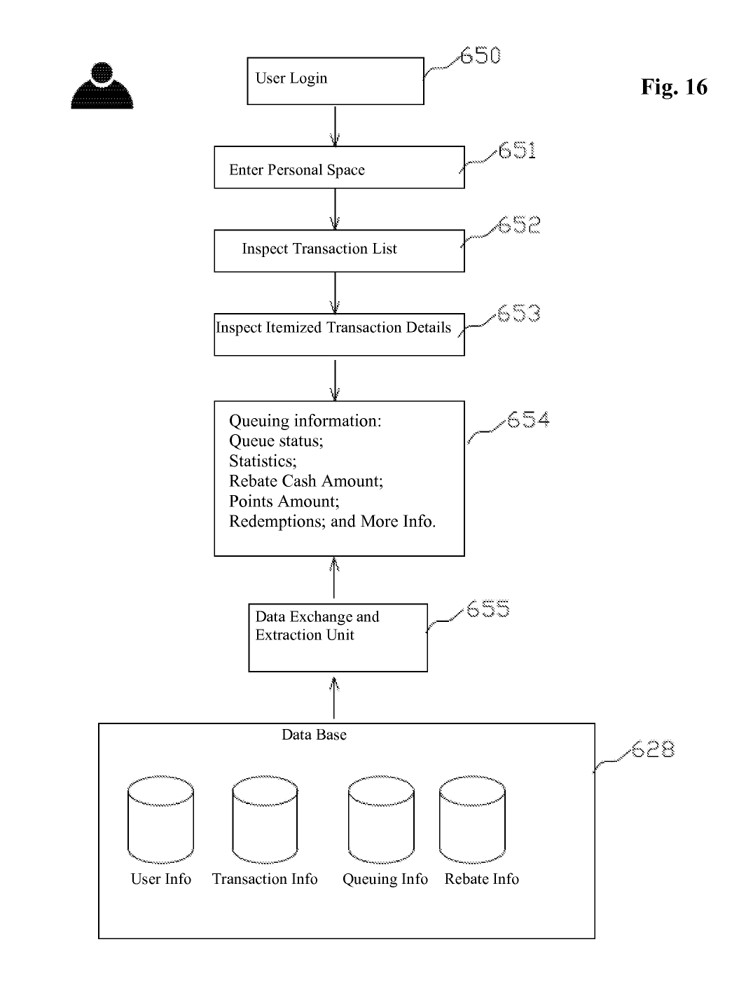

FIG. 16 is a flow chart of a rebate distribution itemization list shown to a registered user according to some exemplary embodiment of the present invention. After a User Login 650 to his or her Personal Space 651, Transaction Lists 652 and Itemized Transaction Details 653 are available for viewing. The above information can be retrieved from Transitional Data Exchange Units 628 or from Higher Level Data Exchange or Extraction Units 655. Queuing information 654, statistics, rebate amount, points amount are all summarized for the user.

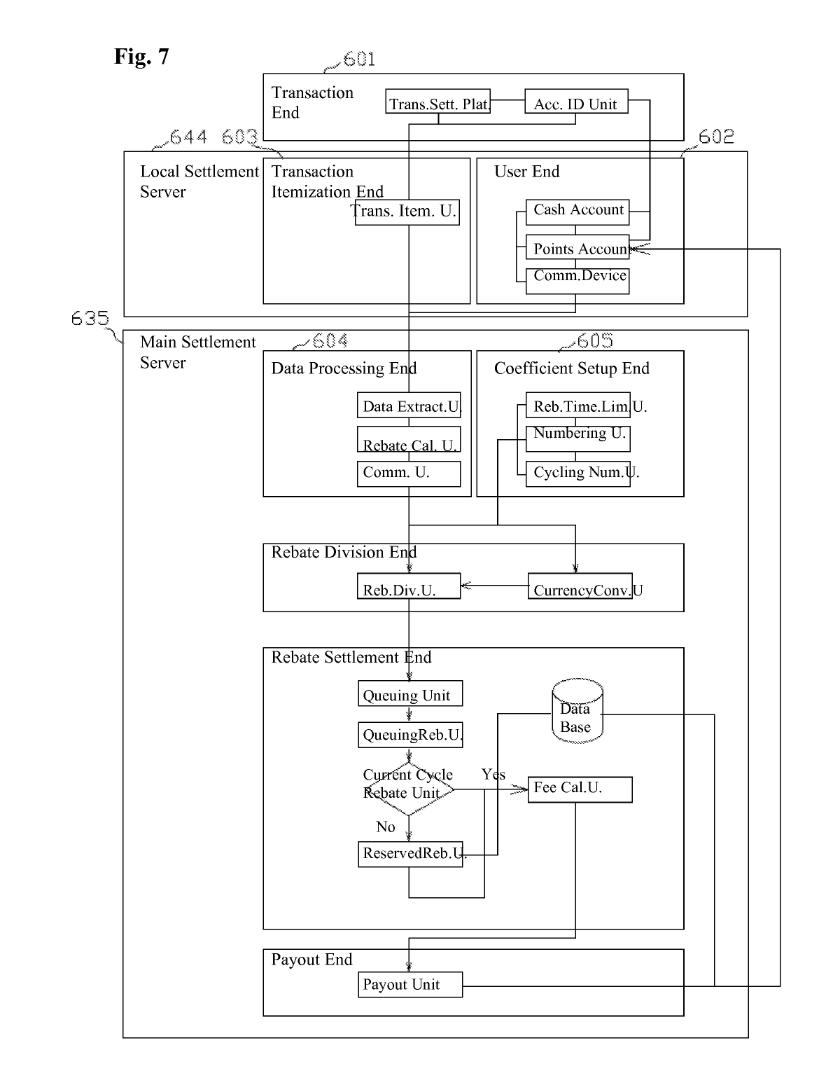

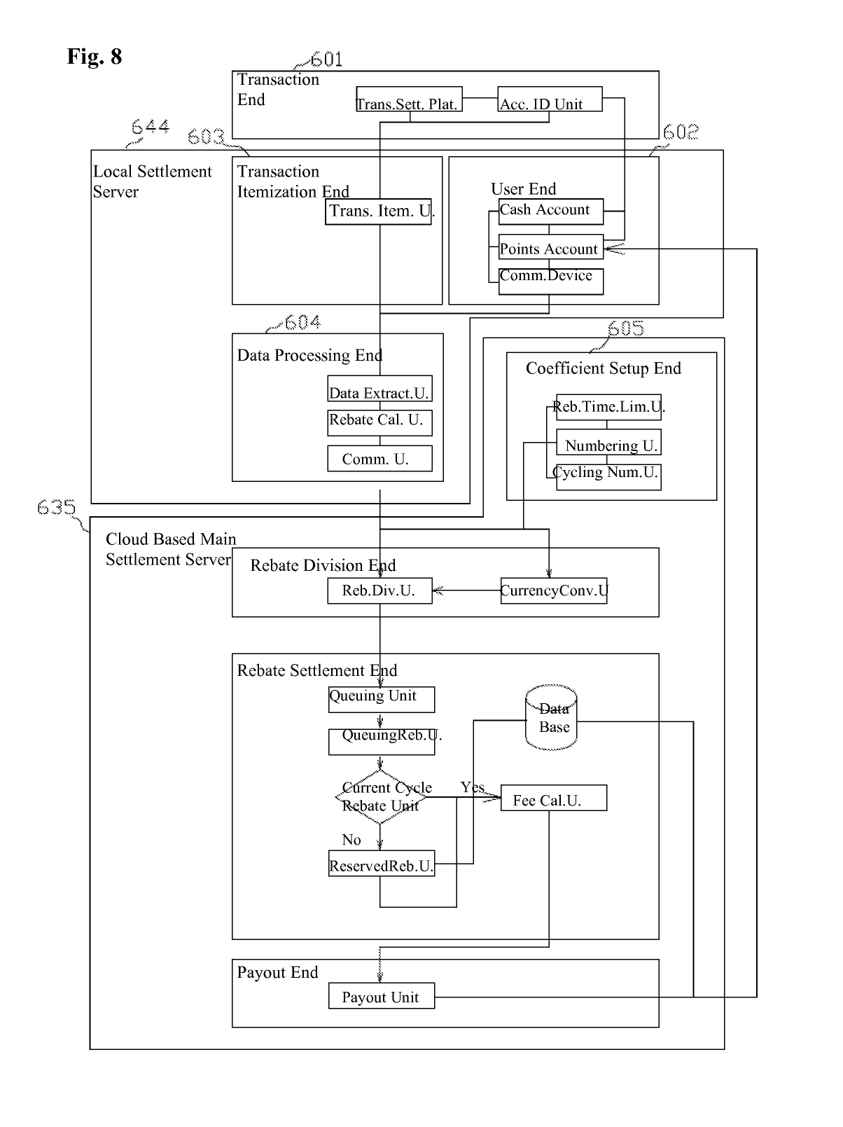

In an exemplary embodiment as illustrated in FIG. 7, a Settlement End 644 comprises a Transaction Itemization End 603 and a User End 602. In FIG. 8, a Data Processing End 604 is added to the Transaction Itemization End 603 and a User End 602. These locally based processing ends can be implemented cheaply and quickly, to allow very fast upload into the cloud based Main Settlement Servers 635, and thus accommodate large scale businesses over the network.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open United as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A transaction rebate computation and distribution system comprising a processor and a computer readable medium having instructions stored thereon, that when executed by the processor cause the processor to generate:
at least one user end, wherein the user end further comprises at least one cash account or one points account;
at least one transaction end, wherein the transaction end further comprises a transaction settlement unit to complete business transactions by a user, and an identification unit to confirm identities of a user and to retrieve the user's account information;
at least one transaction itemization end, wherein the transaction itemization end further comprises a transaction itemization unit connected to the transaction settlement unit and to the identification unit, to generate a transaction itemization list associated with so identified user;
at least one data processing end, wherein the data processing end further comprises:
a data extraction unit, connected to the transaction itemization unit, to retrieve data related to business transactions;
a rebate calculation unit, connected to the data extraction unit, to calculate percentages of rebate from business transactions, to set aside a percentage of queued rebate and a percentage of reserved rebate; and
a communication unit;
at least one coefficient setup end, wherein the coefficient setup end further comprises:
a rebate time limit unit to setup time period from a begin time and an end time;
a numbering unit to arrange time period in a preset order; and
a cycling number unit to preset a cycling number used in calculating rebates;
at least one rebate division end, wherein the rebate division end further comprises:
a rebate division unit to divide a total transaction amount and redistributed the amount into subunits based on decimal numbering system of ten, and
a currency conversion unit connected to the rebate division unit and communication unit to convert virtual and actual currencies based on exchange rates;
at least one rebate settlement end, wherein the rebate settlement end further comprises:
a queuing unit, connected to the rebate division unit, to add new queuing numbers into appropriate queues and to connect them to the transaction itemization list;
a queuing rebate unit to determine which queuing number qualifies for rebate and to compute an amount based on the ratio of the queuing number to the cycling number, preset by the cycling number unit;
a current cycle rebate unit, connected to the queuing rebate unit, to determine which queuing number did or did not receive any rebate;
a reserved rebate unit to distribute reserved rebate to queuing numbers that did not receive rebate from the queuing rebate unit; and
a fee calculation unit to compute the currency or points amount;
at least one payout end, comprising a payout unit, connected to the fee calculation unit and to a user's cash and points account, to make deposit accordingly.

2. The transaction rebate computation and distribution system of claim 1, further comprising at least one cloud based main settlement server, connected to the coefficient setup end, the rebate division end, the rebate settlement end, and the payout end.

3. The cloud based main settlement server of claim 2, is further connected to the data processing end.

4. The transaction rebate computation and distribution system of claim 1, further comprises at least one local settlement server connected to the transaction itemization end.

5. The local settlement server of claim 4, further comprises a data processing unit.

6. The transaction rebate computation and distribution system of claim 1, wherein the reserve rebate unit further comprises:
a rebate identification unit to determine if a queuing number qualifies to receive rebates;
a reserve rebate sub unit to retrieve all information related to the queuing number; and
a verification unit, connected to the reserve rebate sub unit and to a database to retrieve all information related to the queuing number in every queuing unit;
a second fee calculation unit, connected to the verification unit to compute rebate in cash or in points amount; and
a second payout unit, connected to the second fee calculation unit and to a user's cash and points account to make deposit accordingly.

7. The transaction rebate computation and distribution system of claim 1, wherein the main settlement server further comprises:
a rebate type selection unit, connected to the rebate identification unit, a queuing points unit, and the reserve rebate unit, to determine if a queuing number qualifies for either direct rebate or reserve rebate;
a third fee calculation unit, connected to the rebate type selection unit to compute rebate in cash or in points amount; and
a third payout unit, connected to the third fee calculation unit and to a user's cash and points account to make deposit accordingly.

8. The transaction rebate computation and distribution system of claim 1, further comprises a identity verification unit to securely identify a user via magnetic strip cards, account user ID, account password, or security questions.

9. The transaction rebate computation and distribution system of claim 1, wherein the transaction end further comprises a redemption unit, connected to a user's cash or points account, to regulate periodical release of funds or points.

10. The transaction rebate computation and distribution system of claim 1, wherein:
a rebate percentage is set between 0.1%-99.9%;
a cycling number is set to be a natural number equal or larger than 1;
a rebate division rate is set between 0.1%-99.9%;
a rebate preset ratio is set between 0.1%-99.9%; and
a time period is set for every 24 hours.

11. The transaction rebate computation and distribution system of claim 9, wherein:
a rebate percentage is set between 1.0%-10.0%;
a rebate preset ratio is set between 30%-70%; and
a time period is set for every 1 month.

12. The transaction rebate computation and distribution system of claim 10, wherein the cycling number can vary depending on various cycles in rebate calculation.

13. A computer implemented method for use in a computer system that executes program steps recorded in a computer readable medium for accumulating and distributing business transaction rebates, the computer implemented method comprising the steps of:
confirming user identities via an identification unit set up at a business transaction platform;
generating an transaction itemization list associate with the business transaction carried out by the identified user;
setting up rebate period with starting and ending date and time, cycling number and rebate proportion;
calculating rebate amount in cash or in points for qualifying transactions;
selecting a rebate method from direct rebate calculation, queuing rebate calculation, or reserve rebate calculation based on pre-set proportions;
dividing a total transaction amount and redistributing the amount into subunits based on decimal numbering system of ten;
adding new queuing numbers into appropriate queues and connecting them to the transaction itemization list;
determining current rebate queuing numbers in a rebate queue;
determining which queuing number qualifies for rebate and computing a rebated amount based on the queuing number and the cycling number;
computing reserved rebates based on qualification; and
distributing rebates in cash or points into user accounts related to the queuing number and the transaction itemization list.

14. The method for accumulating and distributing business transaction rebates in claim 13, further comprises the steps of converting virtual currencies into actual currencies and distributing rebate in cash or in points into user accounts.

15. The method for accumulating and distributing business transaction rebates in claim 14, further comprising the steps of regulating the distribution of rebate in cash or in points based on preset time periods.

16. The method for accumulating and distributing business transaction rebates in claim 13, further comprising the steps of determining qualification for a queued number to receive direct rebate, and then distribute rebate amount to the user account.

17. The method for accumulating and distributing business transaction rebates in claim 13, wherein
a rebate percentage is set between 0.1%-99.9%;
a cycling number is set to be a natural number equal or larger than 1;
a rebate division rate is set between 0.1%-99.9%;
a rebate preset ratio is set between 0.1%-99.9%; and
a time period is set for every 24 hours.

18. The method for accumulating and distributing business transaction rebates in claim 13, wherein a second time period can be set as 1 month.

19. The method for accumulating and distributing business transaction rebates in claim 17, wherein the cycling number can vary depending on various cycles in rebate calculation.
